(19) United States
(12) Patent Application Publication
(10) Pub. No.: US 2005/0032661 A1
(43) Pub. Date: Feb. 10, 2005

(54) Use of transition metal complexes with nitrogen-containing polydentate ligands as a bleaching catalyst and bleaching agent composition

(75) Inventors: Ulrike Kunz, Gelnhausen (DE); Harald Jakob, Hasselroth (DE); Astrid Dorfer, Grundau (DE)

Correspondence Address: FITCH, EVEN, TABIN & FLANNERY, Suite 401L, 1801 K Street, NW, Washington, DC, 20006-1201, US

(73) Assignee: Degussa AG

(21) Appl. No.: 10/464,852

(22) Filed: Jun. 19, 2003

(30) Foreign Application Priority Data
Jun. 21, 2002 (DE) 102 27 775.3

(51) Int. Cl. C11D 7/18

(52) U.S. Cl. 510/311

(57) ABSTRACT

The present invention is directed to transition metal complexes that are used as bleaching catalysts for peroxy compounds. The complexes contain a pentadentate ligand, which can be open-chain or cyclic. The ligand has the structure: 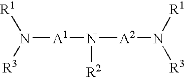
wherein in cyclic ligands the two R¹ together form 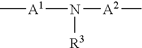
   Preferred complexes are:

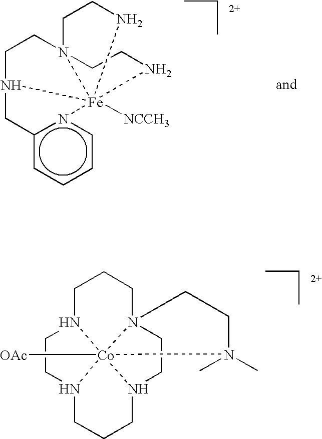

### CROSS REFERENCE TO RELATED APPLICATIONS

This application claims priority to German Application No. 102 27 775.3, filed Jun. 21, 2002, which is incorporated in its entirety herein by reference.

### FIELD OF THE INVENTION

The present invention relates to the use of transition metal complexes with nitrogen-containing polydentate ligands as bleaching catalysts and to bleaching agent compositions comprising such catalysts. The activity of peroxy compounds in washing, bleaching and cleaning processes at low temperature is increased by the transition metal complexes.

### BACKGROUND OF THE INVENTION

Inorganic peroxy compounds (particularly hydrogen peroxide and compounds which liberate hydrogen peroxide, such as sodium perborate monohydrate, sodium perborate tetrahydrate and sodium percarbonate) have been employed for a long time as oxidizing agents in bleaching, washing and cleaning processes. Typically, sufficiently rapid bleaching of soiled textiles requires a temperature of at least 80° C. However, the oxidizing action of inorganic peroxygen compounds at reduced temperature can be improved using bleaching activators. These activators are, in particular, N- and O-acyl compounds, for example polyacylated alkylenediamines (such as tetraacetylethylene-diamine (TAED)), acetylated glycolurils, N-acetylated hydantoins, diketopiperazines, carboxylic acid anhydrides, carboxylic acid esters (such as, in particular, sodium nonanoyloxy-benzenesulfonate (NOBS)), and acylated sugar derivatives.

Using a combination of a peroxy compound and an activator, bleaching can be carried out at about 60° C. instead of above 80° C. without a loss in activity. In efforts to carry out washing and bleaching below 60° C., the use of transition metal complexes (in particular complexes of manganese, iron, cobalt and copper), with at least one polydentate organic ligand (in particular nitrogen-containing ligands), has been described in many documents. Reference is made by way of example to the complexes described in: EP 0 544 490, WO 98/54282, WO 00/12808, WO 00/60043, WO 00/52124, EP 0 392 592, WO 99/64156 and WO 00/12667.

Unfortunately, attempts to use transition metal complexes below 60° C. have been only partially successful. If reactivity is too high, there is the risk of a change in the colour of dyed textiles and, in the extreme, of oxidative damage to the fibres. Furthermore, some complexes decompose the peroxygen compound without a bleaching action, are insufficiently stable to hydrolysis, or are susceptible to oxidation.

Cyclic and open-chain pentadentate aminic ligands are also known (see DE 100 51 317 A1, EP 055 519 A2 and WO 00/12808). These catalysts are suitable for increasing the oxidizing and bleaching action of hydrogen peroxide and further increases can be achieved by combining the bleaching catalyst with an activator capable of forming a peroxycarboxylic acid in the presence of a source of hydrogen peroxide. As has been shown in practice, different properties are required in washing, bleaching and cleaning compositions and the products that are presently available do not fully meet the diverse needs of the trade.

### DESCRIPTION OF THE INVENTION

The present invention is based upon the discovery that transition metal complexes having a transition metal from the series consisting of manganese, iron, cobalt or copper are very active and gentle bleaching catalysts if the complexes also have at least one nitrogen-containing polydentate ligand with a structure according to the description provided herein.

The invention thus provides transition metal complexes with at least one nitrogen-containing ligand as a bleaching catalyst for activation of a peroxy compound or of oxygen. The complex may be mono- or polynuclear, the transition metal (M) may be manganese, iron, cobalt or copper, and the nitrogen-containing ligand (L) is at least pentadentate, can be cyclic or open-chain and has the general formula: 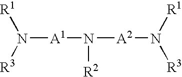
wherein:
A¹ and A² independently of one another are chosen from the series consisting of ethylene and 1,3-propylene, wherein propylene can have a functional substituent in the 2-position,
the two R¹ groups together can represent 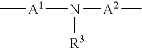
   to form a tetraaza ring,
R² in cyclic ligands is chosen from the series consisting of H, alkyl and —(CH₂)ₙ-Z, wherein n is 1 or 2 and Z is a substituent from the series consisting of COOH, CONR⁴₂, NH₂, NHR⁴, NR⁴₂, 2-pyridyl, imidazol-2-yl, 1,3-oxazolin-2-yl and C(O)—NHR⁴,
R² in open-chain ligands is chosen from the series consisting of 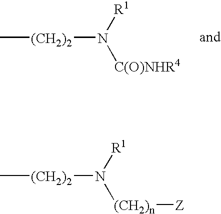
the radicals R¹ in open-chain ligands independently of one another are chosen from the series consisting of H and alkyl
and the radicals R³ and R⁴ in open-chain or cyclic ligands independently of one another are chosen from the series consisting of H and linear, cyclic or branched alkyl and R³ additionally can be a radical C(O)—NHR⁴.

The present invention is also directed to bleaching agent compositions which comprise a peroxy compound, in particular a source of hydrogen peroxide, and a transition metal complex in an amount effective for activation of the peroxy compound. The transition metal complex can be mono- or polynuclear and contains as the transition metal one from the series consisting of manganese in the valency level II to IV, iron in the valency level II or III, cobalt in the valency level II or III and copper in the valency level I or II. Depending on the number of heteroatoms capable of ligand formation and their steric alignment in the ligand L, the complex can contain one or more transition metal atoms, preferably one or two metal atoms of the same type. The complex has the general formula
[LₘMₙXₒ]Yₚ

In this formula, L denotes the ligand to be used according to the invention, M denotes a transition metal atom from the above-mentioned series, X denotes a coordinating neutral or mono- or polyvalent ligand for saturation of the ligand sphere and Y denotes a non-coordinating counter-ion, which can be anionic or, if the sum of anionic ligands X and ionic substituents in the ligand L exceeds the sum of the valency of the metal atoms M, can also be cationic. The index m represents an integer in the range from 1 to 4, in particular 1 or 2, the index n represents an integer, preferably 1 or 2, the index o represents zero or an integer in the range from 1 to 8 and the index p represents zero or an integer in order to achieve a complete charge compensation. Y can also be a substituent, such as carboxylate or sulfonate, in the ligand.

According to a preferred embodiment, the radicals R¹ to R⁴ or the C atoms of the nitrogen-containing ring system directly contain hydrophilic substituents in order to increase the solubility of the complex. Examples of these are salt-forming functional substituents and hydroxyalkoxy groupings, which can also contain one or more ether bridges. Examples of other substituents include OH, COOH, SO₃H, NH₂, N⁺(alkyl)₄, SO₃⁻, CO₃⁻, Cl, F, (C₁-C₄)-alkoxy, (C₁-C₄)alkyl, phenyl, benzyl, pyridyl and 2-pyridylmethyl.

The chemical name for some preferred examples of suitable ligands and formulae of some complexes containing them follow below:
N,N-bis(2-aminoethyl)-N′-(2-pyridylmethyl)-ethane-1,2-diamine (TrenPy) 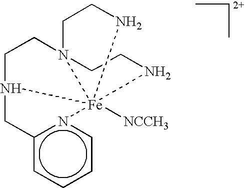
tris[(N′-tert-butylureayl)N-ethyl]amine (Trenta) 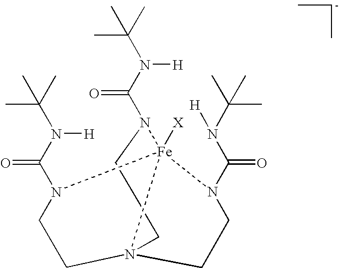
N-(N′,N′-dimethylaminoethyl)-1,4,8,11-tetraazacyclotetradecane (MATATD) 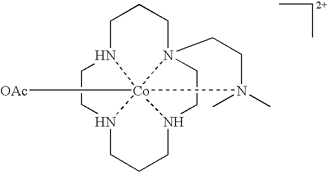
1-(2-pyridylmethyl)-1,4,8,11-tetraazacyclotetradecane (for n=1) (PMTATD) 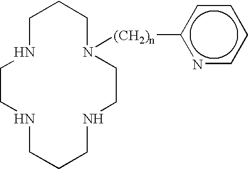
1-(2-carboxyethyl)-1,4,8,11-tetraazacyclotetradecane (for n=2) 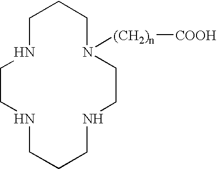
10-methyl-1,4,8,12-tetraazacyclopentadecan-10-amine (for m=0 and n=1) (MATACTD) 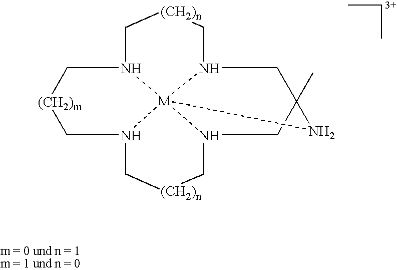
The Co complex of TrenPy is particularly preferred.

Apart from the ligand L, the catalyst can additionally contain coordinating co-ligands (X). X here can be a mono-, di- or trivalent anion or a neutral molecule, which can be coordinated with the transition metal atom in a mono-, bi- or tridentate manner. The co-ligand is preferably the following groupings: OH⁻, O²⁻, NO₃⁻, PO₄³⁻, CN⁻, SCN⁻, HSO₄⁻, SO₄²⁻, Cl⁻, Br⁻, F⁻, ClO₄⁻, OCN⁻, HCO₃⁻, RS⁻, CO₃²⁻, SO₃²⁻, RSO₃⁻, S₂O₆²—, RCO₂; H₂O, ROH, CH₃CN, NRR′R″.

The counter-ion Y of the complex to be used can be anionic or cationic, wherein the number p is chosen such that complete charge compensation is achieved. The counter-ion Y can preferably have the following meaning: F⁻, Cl⁻, Br⁻, I⁻, NO₃⁻, RSO₃⁻ (R e.g. preferably CF₃), ClO₄⁻, RCO₂⁻, PO₄³⁻, HPO₄²⁻, H₂PO₄⁻, SO₄²⁻, HSO₄⁻, CO₃²⁻, HCO₃⁻, BF₄⁻, PF₆⁻, SO₃²⁻; Li⁺, Na⁺, K⁺, Mg²⁺, Ca²⁺, Ba²⁺.

The bleaching catalysts to be used according to the invention activate elemental oxygen and peroxy compounds. Peroxy compounds are to be understood as meaning, in particular, hydrogen peroxide, compounds which liberate hydrogen peroxide, such as, in particular, sodium perborate monohydrate, sodium perborate tetrahydrate and sodium percarbonate, perphosphates and persulfates, peroxycarboxylic acids and salts thereof and peroxycarboxylic acid bleaching precursors, so-called activators, and mixtures of such substances. Suitable peroxycarboxylic acids can be aliphatic or aromatic in nature and contain one or more peroxycarboxylic acid groups. Aliphatic peroxycarboxylic acids usually contain 1 to 20 C atoms, preferably 1 to 12 C atoms, and the particularly preferred peroxycarboxylic acid is peroxyacetic acid. Among the peroxycarboxylic acids with 2 peroxycarboxylic acid groups, those having 4 to 18 C atoms are preferred. Examples are diperoxyadipic acid, diperoxyazelaic acid, diperoxylauric acid and diperoxydodecanedioic acid, as well as salts of the acids mentioned, for example magnesium salts. Among the aromatic peroxycarboxylic acids there are, in particular, peroxybenzoic acid, m-chlorobenzoic acid, p-sulfonatoperoxybenzoic acid, diperoxyisophthalic acid, phthalimidopercaproic acid, 4,4′-sulfonyl-diperoxybenzoic acid and magnesium salts of these acids.

The peroxycarboxylic acids can also be formed in situ under the use conditions, and in particular from so-called activators, which are, in general, O-acyl compounds and N-acyl compounds. Such compounds form the corresponding peroxycarboxylic acid under perhydrolysis conditions in the presence of hydrogen peroxide or a source of hydrogen peroxide. Activators which are particularly prefered are: N,N,N′N′-tetraacetylethylenediamine (TAED), Na 1-methyl-2-benzoyloxybenzene-4-sulfonate, Na nonanoyloxybenzenesulfonate (NOBS), 2-(N,N,N-trimethylammonium)ethyl-sodium 4-sulfophenylcarbonate chloride (SPCC), pentaacetylglucose, phthalic anhydride.

For activation of peroxy compounds, the transition metal complexes to be used according to the invention are, in general, employed in an amount of 0.0001 to 50 wt. %, in particular 0.01 to 20 wt. %, based on the peroxy compounds. Bleaching agent compositions according to the invention comprise at least one peroxy compound and a transition metal complex to be used according to the invention in an active amount. Such compositions expediently comprise 0.0001 to 50 wt. %, preferably 0.01 to 20 wt. % and most preferably 0.01 to 1 wt. % of a transition metal complex with a ligand according to the invention, based on the content of peroxy compounds or the precursor of one.

Bleaching agent compositions according to the invention may additionally comprise one or more surfactants from the series consisting of anionic, cationic, zwitterionic and nonionic surfactants, in particular surfactants such as those used in conventional washing, bleaching and cleaning compositions. Bleaching agent compositions according to the invention can furthermore also comprise organic and/or inorganic builders, such as zeolites. Further constituents can be those such as are used in conventional washing, bleaching and cleaning compositions, including enzymes, pH regulators and conventional alkali metal carriers, such as alkali metal silicate and alkali metal carbonates.

### EXAMPLES

### Example 1

### Preparation of the Ligand N,N-bis(2-aminoethyl)-N′-(2-pyridylmethyl)-ethane-1,2-diamine (TrenPy)

Pyridine-2-carboxaldehyde and tris(2-aminoethyl)amine were reacted in a ratio of 1:5 in accordance with the instructions of Inorg. Chem. (33(21):4664 (1994)) to give TRENPy. Purification was carried out by means of flash chromatography (silica gel, chloroform/methanol/ammonia=10:4:2). (Yield: 74%).

Fe Complex.

500 mg (2.10 mmol) TRENPy were initially introduced into 25 ml of a 1:1 mixture of acetonitrile/methanol, and 762 mg (2.10 mmol) iron(II) perchlorate hexahydrate were added. The solution was stirred for 2 hours at room temperature and then concentrated to approx. half, carefully covered with a layer of ethyl acetate and stored overnight in a refrigerator at −20° C. The violet solid which had precipitated out was filtered off and dried at 50° C. in vacuo. (Yield: 54%)

Co Complex:

The Co complex was also prepared in a similar manner: 200 mg (0.84 mmol) of ligand (TRENPy), which was dissolved in 5 ml methanol beforehand, were added to a solution of 200 mg (0.84 mmol) cobalt(II) chloride hexahydrate and 236 mg (1.68 mmol) sodium perchlorate in 2 ml water. A dark red solution was formed. After stirring for 10 min at room temperature, air was passed moderately through the solution in the course of 2 hours. The solution was left to stand overnight at room temperature and then concentrated completely and the residue was dried in air. (Yield: 98%, red-brown solid)

### Example 2

### Preparation of the Ligand N-(N′,N′-dimethylaminoethyl)-1,4,8,11-tetraazacyclotetradecane (MATATD)

A solution of 270 mg (1.87 mmol) 1-chloro-2-dimethylaminoethane hydrochloride in 2.0 ml dimethylformamide was slowly added to 1.48 g (7.40 mmol) 1,4,8,11-tetraazacyclotetradecane (Cyclam) in 40 ml dimethylformamide at 110-120° C., the mixture was stirred for 2 hours at 110-120° C. and for a further 12 hours at 5° C. and the excess Cyclam was then filtered off. The filtrate was largely evaporated in vacuo. The oily residue was taken up in 10 ml water and the solution was brought to pH=12 with 30 percent aqueous sodium hydroxide solution and then extracted with 4×50 ml chloroform. The combined organic phases were dried over anhydrous magnesium sulfate and the solvent was distilled off in vacuo. 50 ml methyl tert-butyl ether were added to the residue and the mixture was filtered again. After distillation of the solvent, the residue was taken up in a little ethanol and the product was precipitated as the tetrahydrochloride with concentrated hydrochloric acid. Yield: 98% (colourless, crystalline solid).

Co Complex:

676 mg (1.62 mmol) of the tetrahydrochloride in 5.0 ml methanol were brought to pH=13 with 30 percent aqueous sodium hydroxide solution and the solution was stirred for 2 hours at room temperature. 910 mg (6.48 mmol) sodium perchlorate and 403 mg (1.62 mmol) cobalt(II) acetate tetrahydrate, which was dissolved in a little water beforehand, were then added in succession. Atmospheric oxygen was then passed through the solution at room temperature in the course of 45 minutes, a fine beige-brown precipitate being formed. This was filtered off and dried in vacuo at 50° C.

### Examples 3 to 7

### Catalytic Action of Complexes

The complexes of examples 1 and 2 and complexes prepared in an analogous manner or a manner known from the literature were investigated for their catalytic action by means of the Morin test and in some cases by means of a washing test.

Morin test: A sodium perborate monohydrate solution, a methanolic solution of tetraacetylethylenediamine and a dilute solution of the combination to be investigated are added to an aqueous Morin solution. After intensive mixing, the extinction/transmission is measured at 400 nm after 30 minutes at 30° C. The blank value is measured in the absence of the combination to be investigated.

Washing test: Laboratory washing apparatus type ATLAS LAUNDER-OMETER; Temperature: 30° C.; Washing time: 30 minutes; Water hardness: 14°d Staining: tea, in some cases also grass on cotton. Detergent recipe:
12.2% anionic surfactant
7.7% nonionic surfactant
2.0% soap
34.8% zeolite A
4.2% polycarboxylate
0.5% phosphonic acid
4.1% corrosion inhibitor
1.1% magnesium silicate
1.1% greying inhibitor (CMC)

1. A transition metal complex which acts as a catalyst for the activation of a peroxy compound or of oxygen, comprising a transition metal (M) and a nitrogen-containing ligand (L), wherein said complex is mono- or polynuclear, the transition metal (M) is manganese, iron, cobalt or copper and the nitrogen-containing ligand (L) is at least pentadentate, can be cyclic or open-chain and has the general formula 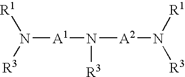
wherein A¹ and A² independently of one another are chosen from the series consisting of ethylene and 1,3-propylene, wherein propylene can have a functional substituent in the 2-position, wherein the two R¹ groups together can represent 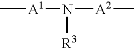
to form a tetraaza ring,
R² in cyclic ligands is chosen from the series consisting of H, alkyl and —(CH₂)ₙ-Z, wherein n is 1 or 2 and Z is a substituent from the series consisting of COOH, CONR⁴₂, NH₂, NHR⁴, NR⁴₂, 2-pyridyl, imidazol-2-yl, 1,3-oxazolin-2-yl and C(O)—NHR⁴,
R² in open-chain ligands is chosen from the series consisting of 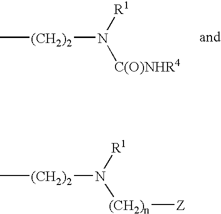
the radicals R¹ in open-chain ligands independently of one another are chosen from the series consisting of H and alkyl;
and the radicals R³ and R⁴ in open-chain or cyclic ligands independently of one another are chosen from the series consisting of H and linear, cyclic or branched alkyl and R³ additionally can be a radical C(O)—NHR⁴.

2. The transition metal complex of claim 1, wherein said ligand (L) is a cyclic ligand based on 1,4,8,11-tetraazacyclotetradecane with a radical, bonded to an N atom, from the series consisting of 2-pyridylmethyl, —(CH₂)ₙ—COOH and —(CH₂)₂—CON(alkyl)₂.

3. The transition metal complex of claim 1, wherein said ligand (L) is an open-chain ligand of the general formula: 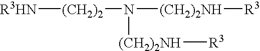
wherein R³ represents —C(O)NH⁺ butyl, or of the general formula 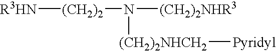
wherein R³ is H or C, to C₄-alkyl is used.

4. The transition metal complex of any one of claim 1-3, wherein said complex has the general formula [LₘMₙXₒ]Y_{P},
wherein L denotes a ligand according to one of claims 1 to 3,
M denotes a transition metal from the series consisting of Mn(II) to Mn(IV), Fe(II), Fe(III), Co(II), Co(III), Cu(I) and Cu(II), in particular Co(II) or Co(III),
X denotes a coordinating neutral or charged mono- or polyvalent ligand for saturation of the ligand sphere and
Y denotes a non-coordinating counter-ion which can be anionic or, if the sum of anionic substituents in the ligand L exceeds the sum of the valency of the metal atoms M, can also be cationic,
m denotes an integer in the range from 1 to 4, in particular 1 or 2,
n denotes the number 1 or 2,
o denotes zero or an integer in the range from 1 to 8 and
p denotes zero or an integer in the range from 1 to 8, in order to achieve complete charge compensation.

5. A bleaching agent composition comprising a peroxy compound and the transition metal complex of any one of claims 1-3 present in an amount effective for the activation of said peroxy compound.

6. A bleaching agent composition comprising a peroxy compound and the transition metal complex of claim 4 present in an amount effective for the activation of said peroxy compound.

7. The bleaching agent composition of claim 6, wherein said peroxy compound is chosen from the group consisting of hydrogen peroxide; a source of hydrogen peroxide; a peroxycarboxylic acid having 2 to 18 C atoms; a combination of a source of hydrogen peroxide and a peroxycarboxylic acid precursor; and from mixtures thereof.

8. The bleaching agent composition of claim 7, wherein said peroxy compound is an alkali metal perborate monohydrate tetrahydrate or alkali metal percarbonate.

9. The bleaching agent composition of claim 7, wherein said peroxy compound is a combination of a source of hydrogen peroxide and a peroxycarboxylic acid precursor, said peroxycarboxylic acid precursor being either an O-acyl or N-acyl compound.

10. The bleaching agent composition according to claim 7, further comprising one or more surfactants.

11. The bleaching agent composition of claim 10, wherein said one or more surfactants, are wash-active surfactants.

12. The bleaching agent composition according to claim 7, further comprising builders.

13. The bleaching agent composition of claim 12, wherein said builders are zeolites.

14. The bleaching agent composition according to claim 10, further comprising builders.

15. The bleaching agent composition of claim 12, wherein said builders are zeolites.

16. A cleaning composition comprising the bleaching agent composition of claim 5 together with one or more surfactants and one or more builders.

17. A cleaning composition comprising the bleaching agent composition of claim 6 together with one or more surfactants and one or more builders.

18. The bleaching agent composition according to claim 7, wherein said transition metal complex comprises 0.0001 to 50 wt. % of said bleaching agent composition based on the content of peroxy compound or precursor thereof.

19. The bleaching agent composition of claim 17, wherein said transition metal complex comprises 0.01 to 20 wt. % of said bleaching agent composition based on the content of peroxy compound or precursor thereof.

20. A method of bleaching a textile comprising contacting said textile with an aqueous solution containing the bleaching agent composition of claim 5 for a time and under conditions sufficient to accomplish said bleaching.

21. The method of claim 20, wherein said method is carried out at a temperature of less than 60° C.

22. A method of bleaching a textile comprising contacting said textile with an aqueous solution containing the bleaching agent composition of claim 6 for a time and under conditions sufficient to accomplish said bleaching.

23. The method of claim 22, wherein said method is carried out at a temperature of less than 60° C.
